(19) United States
(12) Patent Application Publication
(10) Pub. No.: US 2013/0098736 A1
(43) Pub. Date: Apr. 25, 2013

(54) TRANSPORT DEVICE FOR SLABS, COMPRISING AT LEAST TWO LINEAR CONVEYING SECTIONS WHICH CAN PIVOT INDEPENDENTLY OF EACH OTHER

(71) Applicants: Luc Neumann, Dusseldorf (DE); Kilian Kaupper, Recklinghausen (DE); Christian Bilgen, Dusseldorf (DE); Alexander Meyer, Dusseldorf (DE); Tilmann Bocher, Dusseldorf (DE); Marcel Gathmann, Dusseldorf (DE)

(72) Inventors: Luc Neumann, Dusseldorf (DE); Kilian Kaupper, Recklinghausen (DE); Christian Bilgen, Dusseldorf (DE); Alexander Meyer, Dusseldorf (DE); Tilmann Bocher, Dusseldorf (DE); Marcel Gathmann, Dusseldorf (DE)

(73) Assignee: SMS SIEMAG AKTIENGESELLSCHAFT, Dusseldorf (DE)

(21) Appl. No.: 13/520,128

(22) PCT Filed: Dec. 14, 2010
(86) PCT No.: PCT/EP10/69581

§ 371 Date: Jul. 6, 2012

(30) Foreign Application Priority Data
Dec. 29, 2009 (DE) 10 2009 060 824.9

(51) Int. Cl. B65G 47/50; B21B 39/18

(52) U.S. Cl. CPC B65G 47/50; B21B 39/18
USPC 198/339.1

(57) ABSTRACT

A transport device for slabs, which device is arranged between at least two casting machines and at least one rolling mill. The transport device has at least two linear and stationary conveyor sections on which a slab can be conveyed in a conveying direction. The transport device further has at least two linear conveyor sections which are arranged to be pivotable in order to convey a slab at an angle to the conveying direction. In order to improve guidance of the slabs and provide a flexible transport of the slabs from the casting machines to the rolling mill, the at least two linear, pivotable conveyor sections are arranged to be pivotable independently of one another.

The invention relates to a transport device for slabs, which device is arranged between at least two casting machines and at least one rolling mill, wherein the transport device has at least two linear and stationary conveyor sections on which a slab can be conveyed in a conveying direction and wherein the transport device has at least two linear conveyor sections which are arranged to be pivotable in order to convey a slab at an angle to the conveying direction.

Transport devices by which slabs can be transported from at least two casting machines to a rolling mill have long been known in the prior art. Different designs of such devices are described in EP 0 492 226 B1, WO 00/12235, EP 0 593 002 B1, EP 0 867 239 B1, EP 1 127 628 A1, DE 195 24 082 B4, DE 41 37 547 C2, EP 0 682 770 B1 and EP 0 845 308 B1. In that case, two different constructions have proved satisfactory:
1. Parallel ferry, in which a movable conveyor section is moved parallelly from one casting line to the next.
2. Pivoting ferry, in which two movable conveyor sections of different casting lines pivot towards one another and the slab is moved at an angle to the main transport direction.

The present development is concerned with the second construction, the pivoting ferry. For this purpose use can be made of pivotable conveyor sections. Such a solution, which corresponds with that stated in the introduction, is described in EP 0 908 243 B1 and EP 0 908 244 B1. Use is made here of a diverter element which is V-shaped in plan view and which adjoins a linear transport section. The slab can be redirected into and transported in a desired direction by pivotation of this V-shaped diverter element about a vertical axis.

It is advantageous with such a solution that very flexible conveying of the slabs can be provided.

However, the following has proved to be disadvantageous with this solution: The possibility for precise slab guidance significantly reduces at the entry of the slab into the V-shaped diverter element. This is due to the fact that the width of the diverter element at the point of forking thereof necessarily has to increase. Accordingly, the possibility of laterally guiding the slab also decreases.

In addition, as a consequence of widening the guidance of the slab in the region of the entry into the V-shaped diverter element very wide rollers are needed here. Warping of these increases with increasing width, which equally has a negative effect on guidance accuracy. It is self-evident that a solution such as in EP 0 908 243 B1 would never be technically realised.

The present invention therefore has the object of so developing a transport device of the kind stated in the introduction that with use of the transport device according to category and exploitation of the flexibility thereof the stated disadvantages shall be avoided. Accordingly, it is endeavoured to make possible an improved guidance of the slabs during transport thereof from a casting machine to a rolling mill.

Fulfilment of this object by the invention is characterised in that the at least two linear, pivotable conveyor sections are arranged to be pivotable independently of one another about a vertical axis.

The linear and stationary conveyor sections are in that case preferably arranged parallel to one another.

With advantage, the linear conveyor sections are constructed as roller path elements.

At least a part of the linear conveyor sections can be provided with furnace elements, particularly in the form of tunnel furnaces. In that case, it is preferably provided that at least a part of the furnace elements of the linear conveyor sections is independently heatable.

Moreover, at least a part of the linear conveyor sections can be provided with thermal insulating elements. The thermal insulating elements can be closable with respect to heat insulation in the end region.

In addition, at least a part of the linear conveyor sections can be provided with descaling elements. Further, special slab treatment devices are also possible.

The at least two linear, pivotable conveyor sections are preferably arranged to be pivotable about a fulcrum arranged outside the length of the conveyor sections.

Moreover, at least one linear and stationary conveyor section, which follows and adjoins a linear pivotable conveyor section and is arranged at a preferred acute angle to the conveying direction, can be present.

The above object is comprehensively fulfilled by the two-part diverter element in accordance with the invention and the possibility of separate pivotation of the two parts.

It is possible with the proposed design of the transport device to precisely guide the slab even at the forking or at the redirection at an angle to the (main) conveying direction, i.e. the slab guidance is also improved in the region of the diverter, since at the entry region of the slab into the pivotable conveyor section the rollers of the conveyor section precisely predetermine the direction of transport. By contrast to the above-discussed previously known solution a degree of imprecision in the running direction of the slab on entry into the diverter element is thus avoided.

Conveyor rollers of the same length can also be used in the entire region of the transport device, i.e. rollers with increased width are not needed at the entry of the diverter element. This similarly improves guidance accuracy, since warping of the rollers can be kept small.

Advantages in terms of energy also arise: In the case of specific steel categories (for example silicon steels) it can be necessary to employ higher temperatures. The temperature of predetermined furnaces with which the relevant conveyor sections are provided can then be increased. This temperature increase can in that case be provided only for a part of the pivotable conveyor sections. The conveyor sections which do not convey slabs of the relevant steel categories can be kept at the standard temperature.

The periodic shutting down of a part of the conveyor sections, for example for maintenance purposes, is also possible without problems. The transport device can still convey further slabs to a certain extent. A simpler possibility of exchanging conveyor rollers also arises as a result.

The invention can be used in all casting/rolling plants provided with more than one casting machine. Transport from one line to another can be carried in general.

The capacity of the plant overall and the buffer times of tunnel furnaces can be increased in accordance with the invention. The advantageous flexibility arises even with two lines, but is preferably realised with three lines.

Several slabs can be conveyed in the ferry region parallelly in time on the proposed transport device. Thus, particularly in the case of high-production plants (annual tonnage of more than three million tons) the bottleneck which often arises due to the ferries is avoided. Instead, slabs can be conveyed simultaneously from a secondary line in the ferry and to the main line.

The buffer capacity of the furnaces is advantageously higher with the proposed concept for a constructional length of the plant the same as in a parallel ferry plant.

Embodiments of the invention are illustrated in the drawing, in which:

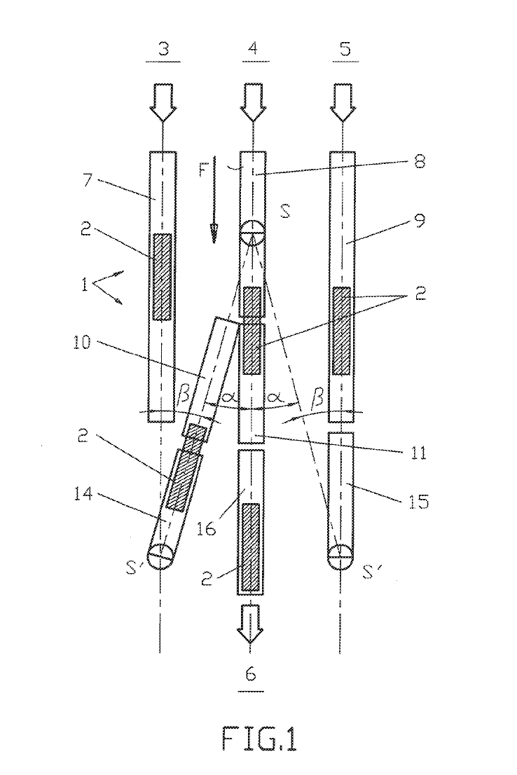

FIG. 1 shows, schematically in plan view, a transport device by which slabs can be conveyed from three casting machines to a rolling mill, wherein during transport of the slabs these undergo at least partly a reversal of direction,

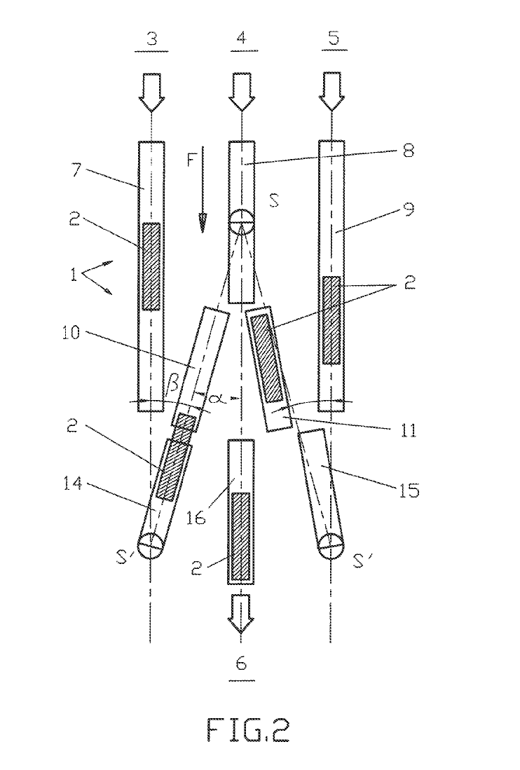

FIG. 2 shows the illustration according to FIG. 1 at a somewhat later point in time,

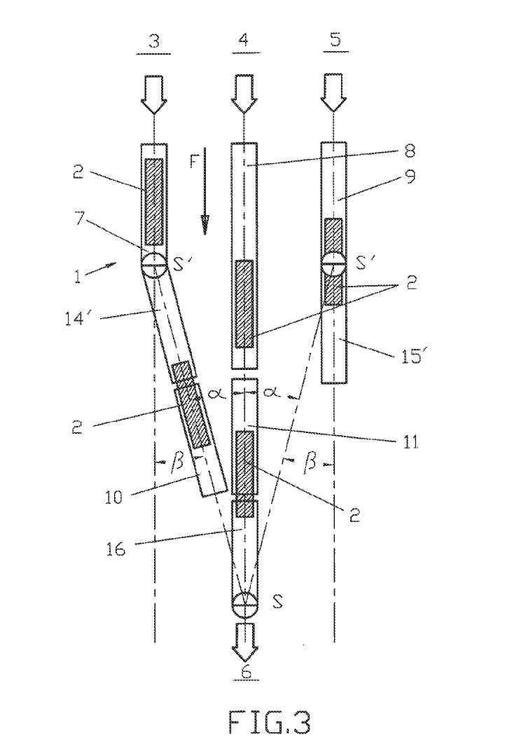

FIG. 3 shows, schematically in plan view, a transport device in a form of embodiment modified with respect to FIG. 1, wherein a reversal of direction during transport of the slabs can be dispensed with,

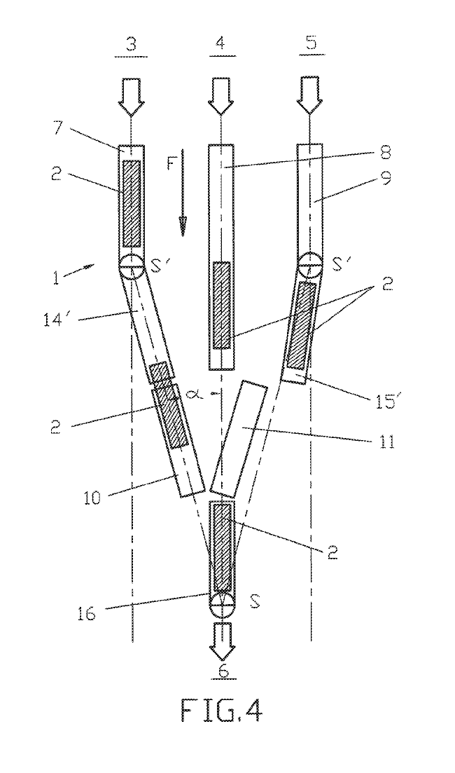

FIG. 4 shows the illustration according to FIG. 3 at a somewhat later point in time,

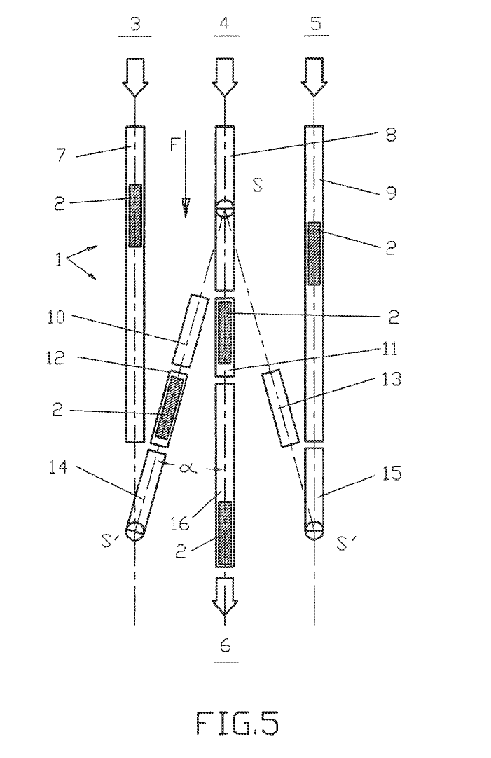

FIG. 5 shows, schematically in plan view, a transport device in a further form of embodiment modified with respect to FIG. 1,

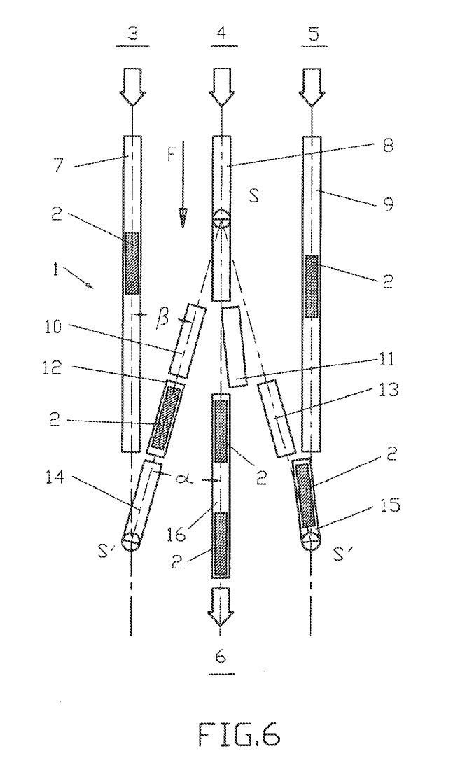

FIG. 6 shows the illustration according to FIG. 5 at a somewhat later point in time,

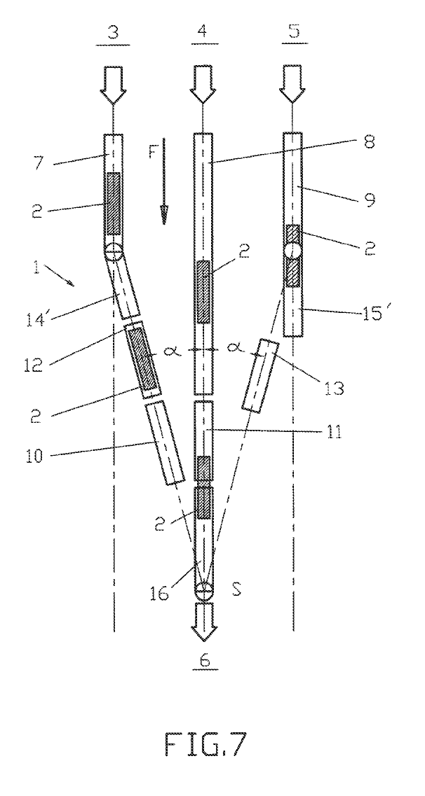

FIG. 7 shows, schematically in plan view, a transport device in a further form of embodiment modified with respect to FIG. 3,

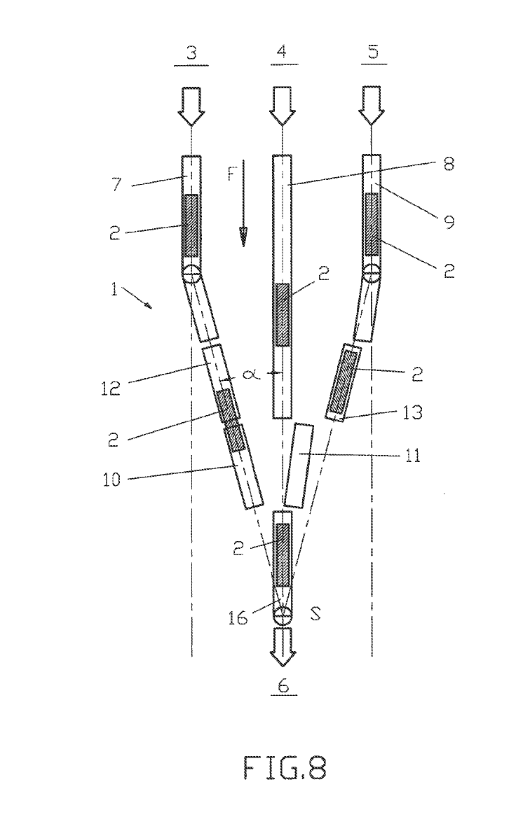

FIG. 8 shows the illustration according to FIG. 7 at a somewhat later point in time,

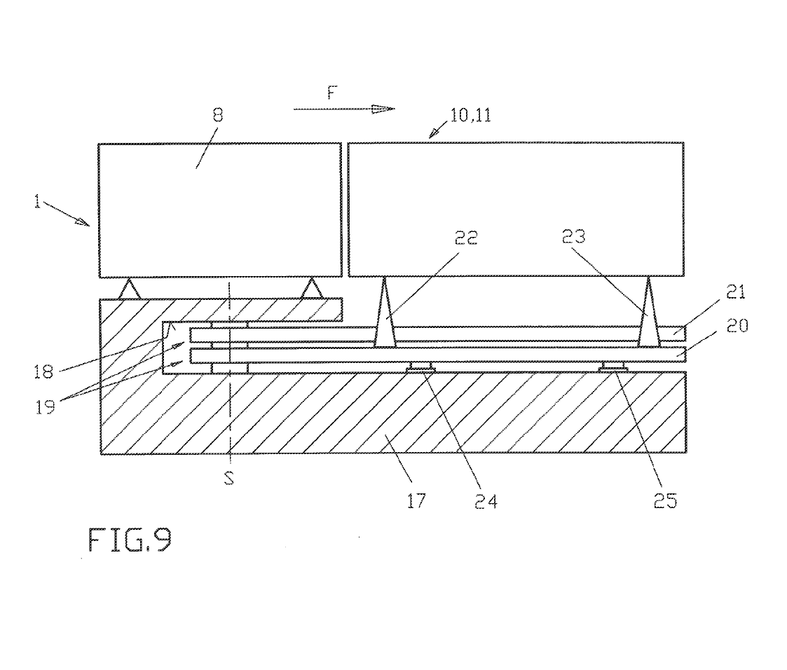

FIG. 9 shows the sectional side view of a part of the transport device,

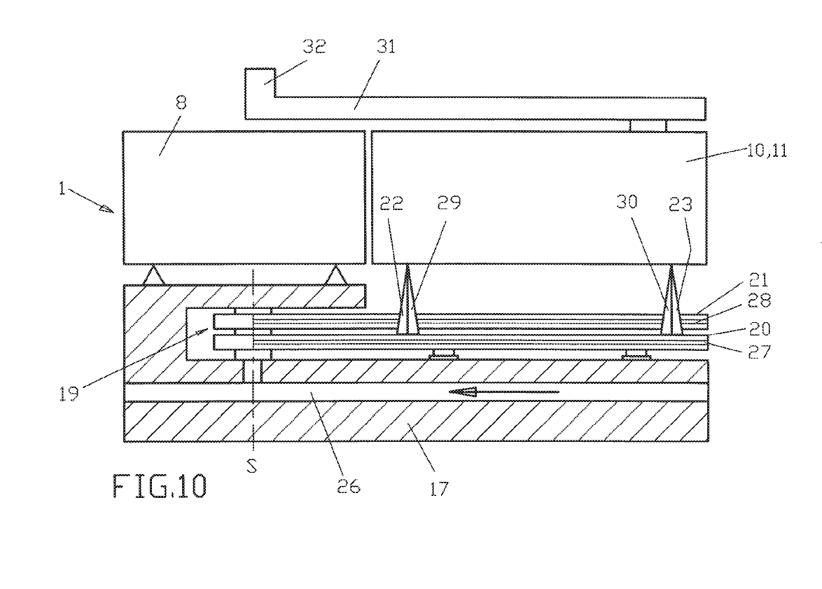

FIG. 10 shows the sectional side view of a part of the transport device according to a form of embodiment alternative to FIG. 9,

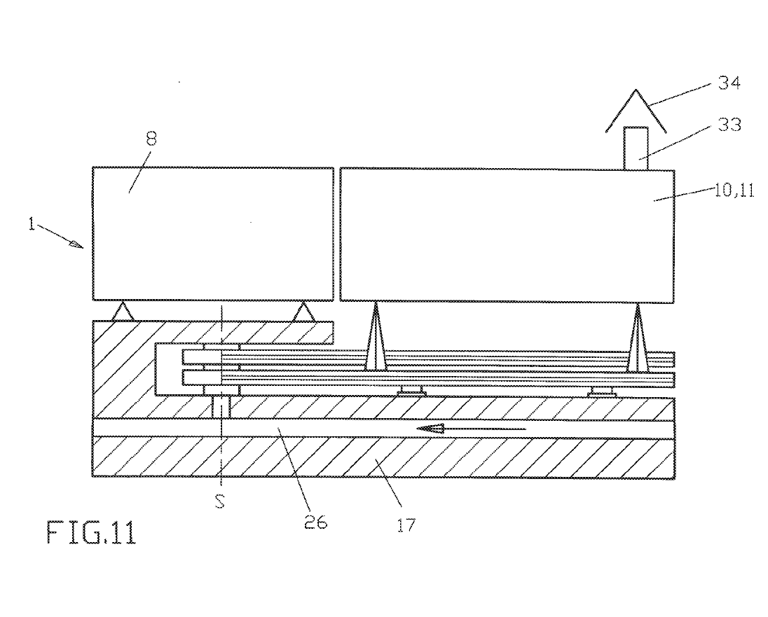

FIG. 11 shows the sectional side view of a part of the transport device according to a further form of embodiment alternative to FIG. 9 and

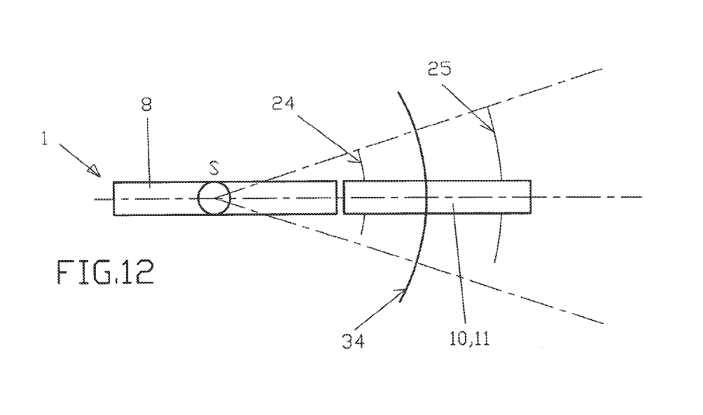

FIG. 12 shows the plan view of the part of the transport device illustrated in FIG. 11.

A transport device 1 can be seen in FIG. 1, by which slabs 2 are conveyed from, in total, three casting machines 3, 4 and 5 to a hot-rolling mill 6. In that case a (main) conveying direction F is present. The present invention is obviously just as usable in the case of only two or in the case of more than three casting machines. This also applies to the number of rolling mills, although in the exemplifying embodiment only one is present.

The cast slabs 2 are conveyed in FIG. 1 from above (from the casting machines 3, 4, 5) to below (to the rolling mill 6). For this purpose the transport device 1 has in the region illustrated at the top in FIG. 1 three stationary linear conveyor sections 7, 8 and 9 arranged in the present instance parallel to one another; however, it is just as possible for the conveyor sections 7, 8, 9 to run not parallel, but an angle to one another.

In the illustrated position of the individually depicted conveyor sections it is possible for the slabs 2 of the middle casting machine 4 to be conveyed linearly and directly—coming from the stationary conveyor section 8—without reversal of direction.

However, the slab transport from the two laterally arranged conveyor sections 7 and 9 is carried out by a double reversal of direction of the slabs 2. For this purpose, provided in the middle region of the transport device 1 are two pivotable conveyor sections 10 and 11 which can be pivoted about a fulcrum S and, in particular, independently of one another. Moreover, two similarly pivotably arranged conveyor sections 14 and 15 are present in the lower region of the transport device and can be pivoted about respective fulcra S′, which are arranged in the axial end region of these sections.

The fulcrum S of the pivotable conveyor section 10 or 11 lies outside the axial length of the section 10 or 11 and preferably below a stationary conveyor section.

The slabs 2 coming from the conveyor sections 7 and 9 are thus initially conveyed downwardly in FIG. 1 and in that case conducted into the respective pivotable conveyor sections 14 and 15, which for this purpose have been moved into alignment with the conveyor sections 7 and 9 respectively (illustrated for the conveyor section 15 in FIG. 1). When the slab 2 is received by the pivotable conveyor sections 14 and 15, these pivot about the fulcrum S′ into the position illustrated in FIG. 1 for the conveyor section 14; the pivot angle for the conveyor section 14 in FIG. 1 is denoted by β. At the same time, the pivotable conveyor sections 10 and 11 are pivoted into the position which is illustrated in FIG. 1 for the conveyor section 10.

Consequently, the slab 2 can now move—counter to the conveying direction F—from the conveyor section 14 or 15 into the conveyor section 10 or 11, respectively. If the slab 2 is located entirely on the conveyor section 10 or 11, the conveyor section 10 or 11 pivots through the depicted angle α back into alignment with the conveyor section 8 or the stationary conveyor section 16 arranged at the bottom in continuation of the conveyor section 8; this setting is illustrated in FIG. 1 for the conveyor section 11.

Through repeated reversal of direction of the slab 2 the slab can now be moved from the section 10 or 11 to the section 16 and onward to the rolling mill 6.

The time sequence is illustrated in FIGS. 1 and 2 for two successive points in time.

In this connection it is significant that the two linear, pivotable conveyor sections 10 and 11 are arranged to be pivotable independently of one another. A precise slab guidance can thus take place particularly at its axial end which is upper in FIG. 1.

The same principle for an alternative embodiment of the invention is illustrated in FIGS. 3 and 4, again for successive points in time. The pivotable conveyor sections 14 and 15 in FIGS. 1 and 2 here correspond with the similarly pivotably arranged conveyor sections 14′ and 15′, which can pivot through the angle β. The slab conveying can take place here from the casting machines 3, 4, 5 to the rolling mill 6 without a reversal of direction.

It is again important that the two linear, pivotable conveyor sections 10 and 11 are arranged to be pivotable independently of one another.

A further alternative form of embodiment of the invention is illustrated in FIGS. 5 and 6 again for two successive points in time. This solution is similar to that according to FIGS. 1 and 2, because a double reversal of direction is also necessary here, for the transport of the slabs 2 by the lateral conveyor sections 7 and 9, in order to convey them from the casting machines 3 and 5 to the rolling mill 6.

However, the solution differs from that according to FIGS. 1 and 2 in that stationary conveyor sections 12 and 13 are arranged between the pivotable conveyor sections 10 and 11 and the pivotable conveyor sections 14 and 15. In the case of the slabs 2 from the casting machine 3 these are accordingly transported by way of the conveyor sections 7-14-12-10-16 to the rolling mill 6. The respective reversal of direction takes place on the conveyor sections 14 and 10.

A further alternative form of embodiment of the invention is illustrated in FIGS. 7 and 8. This follows the solution according to FIGS. 3 and 4. However, a stationary conveyor section 12 or 13 is also arranged here between the pivotable conveyor sections 14′ and 15′ and the pivotable conveyor sections 10 and 11, respectively. Conveying of the slabs 2 from all casting machines 3, 4, 5 to the rolling mill 6 can again take place here without reversal of direction.

The slab transport can thus be carried out with a minimum number of transport phases. The slab transport can be carried out in a minimum time. Accordingly, the throughput of the plant is higher than with conventional plants.

Moreover, the flexibility of the transport is high, particularly if parts of the plant are not needed and are shut down. It is thus of advantage that individual casting machines can be periodically shut down without problems. The slab transport can be continued in an efficient and flexible manner.

Each transport section can be separately heated by a furnace (not illustrated), wherein tunnel furnaces are preferred.

Equally preferred are induction heating means.

Provision can also be made for a sample removal station to be arranged to follow a conveyor section. The conveyor sections 14 and 15 provided for the reversal of direction are particularly suitable for this purpose.

Special devices, which serve for descaling, selective oxidisation or surface treatment of the slab, can selectably also be integrated in all conveyer sections.

Some details of the technical design of the transport device 1 are illustrated in FIGS. 9 to 12.

A part of the transport device 1 is illustrated in FIG. 9 and, in particular, the stationary conveyor section 8 according to FIG. 1 or FIG. 2 and the pivotable conveyor sections 10 and 11 (which are successive in the illustration according to FIG. 9) following in the conveying direction F. An analogous design can also be provided for the stationary conveyor section 16 and the pivotable conveyor sections 10 and 11 disposed in front thereof, such as is provided, by way of example, in FIG. 3 and FIG. 4 (wherein then the conveying direction would point in the other direction).

The foundation 17 carries initially the stationary conveyor section 8. Arranged below the conveyor section 8 in the foundation 17 is a recess 18 in which the pivot bearing 19 for the two pivotable conveyor sections 10 and 11 is arranged. The pivot bearing 19 is constructed as a vertically mounted axle which forms the fulcrum S. The pivot bearing 19 journals two supports 20 and 21 for the two pivotable conveyor sections 10 and 11, i.e. each support 20 or 21 carries a conveyor section 10 or 11. Two carrier elements 22 and 23, which are fixedly arranged on the support 20 and carry the conveyor section 10, are indicated for the support 20. This applies analogously to the support 21 (not illustrated in detail).

The supports 20 and 21 are mounted—as is illustrated only for the support 20, but applies analogously to the support 21—mounted on two curved rails 24 and 25, which in plan view (see for this purpose FIG. 12) run arcuately about the fulcrum S. The supports 21, 22 can optionally mesh with the rails 24, 25 by way of toothings. The supports 21, 22 then carry gearwheels, which are rotatable about a horizontal axis and the axis of which faces towards the fulcrum S; the rails 24, 25 are then constructed in the manner of a curved rack. This form of embodiment enables precise pivotable movement by controlled rotational drive of the gearwheels.

FIG. 10 details how the feed and discharge of media or energy can be carried out. The principle illustrated here is appropriate to the media supply also taking place by way of the location of the fulcrum S. For this purpose, at least one media feed duct 26 for combustion gas, air, electricity, water or other required media or energy runs in the foundation 17. The feed direction thereof is indicated by the arrow in the media feed duct 26. The media or the energy is or are led upwardly in the region of the pivot bearing 19 vertically through the shaft of the pivot bearing. At the level of the projection of the supports 20, 21 ducts 27, 28 in the supports 20, 21 lead to the carrier elements 22, 23; further ducts 29, 30 then lead in the carrier elements 22, 23 to the conveyor section 10, 11.

Appropriate rotary conduits by way of which the media and energy supply is carried out are thus formed in the pivot bearing 19.

The discharge of, for example, cooling water takes place in analogous manner in the opposite direction.

However, the discharge of waste gas is undertaken in the embodiment according to FIG. 10 by a duct section 31 (chimney) above the conveyor section 10, 11, along which the waste gas runs up to the position of the fulcrum S. From there a vertically upwardly extending connecting section 32 discharges the waste gas, wherein a design of the connecting section 32 analogous to the feed in the pivot bearing 19 can be provided. Accordingly, here again the waste gas is transferred by means of a rotary conduit to a chimney (not illustrated) in stationary location; the waste gas is then delivery by this to the environment.

An alternative solution for the discharge of waste gas is illustrated in FIG. 11. Whilst the media and energy feed takes place as in FIG. 10, here a chimney 33 arranged in the stationary position on the conveyor section 10, 11 is provided for the discharge of waste gas. The chimney 33 in the case of movement of the conveyor section 10, 11 thus executes, in plan view, an arcuate movement about the fulcrum S. An outlet channel 24, which fellows this arc (see for this purpose FIG. 12), is arranged above the chimney 33. The waste gas is then delivered by the outlet channel 34 to the environment, which is not illustrated. If required, obviously more than one outlet channel 24 can also be provided.

The plan view of the concept according to FIG. 11 is illustrated in FIG. 12. The actuate path around the fulcrum S as well as the rails 24 and 25 and the outlet channel 34 can be seen here.

In general, a design with only a virtual fulcrum S is possible. In this connection, movement of the pivotable conveyor sections 10, 11 takes place solely by way of rollers on rails in the manner of the illustration according to FIGS. 9 to 12. The rotary conduit in the region of the pivot bearing 19 is in this regard thus superfluous, i.e. the supports 20 and 21 end before they reach the pivot axis S. The feed and discharge of media and energy then takes place here in a different manner, for example by way of drag chains.

### REFERENCE NUMERAL LIST

1 transport device

2 slab

3 casting machine

4 casting machine

5 casting machine

6 rolling mill

7 stationary conveyor section

8 stationary conveyor section

9 stationary conveyor section

10 pivotable conveyor section

11 pivotable conveyor section

12 stationary conveyor section

13 stationary conveyor section

14 pivotable conveyor section

14′ pivotable conveyor section

15 pivotable conveyor section

15′ pivotable conveyor section

16 stationary conveyor section

17 foundation

18 recess

19 pivot bearing

20 support

21 support

22 carrier element

23 carrier element

24 rail

25 rail

26 media feed duct

27 duct

28 duct

29 duct

30 duct

31 duct section

32 connecting section

33 chimney

34 outlet channel for waste gas

F conveying direction

S fulcrum

S′ fulcrum

α angle

β angle

1. Transport device (1) for slabs (2), which device is arranged between at least two casting machines (3, 4, 5) and at least one rolling mill (6), wherein the transport device (1) has at least two linear and stationary conveyor sections (7, 8, 9) on which a slab (2) can be conveyed in a conveying direction (F), and wherein the transport device (1) has at least two linear conveyor sections (10, 11) which are arranged to be pivotable in order to convey a slab (2) at an angle (α) to the conveying direction (F), characterised in that the at least two linear, pivotable conveyor sections (10, 11) are arranged to be pivotable independently of one another.

2. Transport device according to claim 1, characterised in that the linear and stationary conveyor sections (7, 8, 9) are arranged parallel to one another.

3. Transport device according to claim 1 or 2, characterised in that the linear conveyor sections (7, 8, 9, 10, 11) are constructed as roller path elements.

4. Transport device according to any one of claims 1 to 3, characterised in that at least a part of the linear conveyor sections (7, 3, 9, 10, 11) is provided with furnace elements, particularly in the form of tunnel furnaces.

5. Transport device according to claim 4, characterised in that at least a part of the furnace elements of the linear conveyor sections (7, 8, 9, 10, 11) is independently heatable.

6. Transport device according to any one of claims 1 to 3, characterised in that at least a part of the linear conveyor sections (7, 8, 9, 10, 11) is provided with thermal insulating elements.

7. Transport device according to claim 6, characterised in that the thermal insulating elements are closable with respect to heat insulation in the end region.

8. Transport device according to any one of claims 1 to 7, characterised in that at least a part of the linear conveyor sections (7, 3, 9, 10, 11) is provided with descaling elements.

9. Transport device according to any one of claims 1 to 8, characterised in that the at least two linear, pivotable conveyor sections (10, 11) are arranged to be pivotable about a fulcrum (S) arranged outside the length of the conveyor sections (10, 11).

10. Transport device according to any one of claims 1 to 9, characterised in that at least one linear and stationary conveyor section (12, 13), which follows and adjoins a linear, pivotable conveyor section (10, 11) and is arranged at an angle (α) to the conveying direction (F), is present.
